(19) United States
(12) Patent Application Publication
(10) Pub. No.: US 2009/0291426 A1
(43) Pub. Date: Nov. 26, 2009

(54) EDUCATIONAL SYSTEM FOR PRESENTING ONE OR MORE LEARNING UNITS TO STUDENTS IN DIFFERENT LEARNING ENVIRONMENTS

(75) Inventor: George Bryan POLIVKA, Owings Mills, MD (US)

Correspondence Address: VENABLE LLP, P.O. BOX 34385, WASHINGTON, DC, 20043-9998, US

(73) Assignee: Laureate Education, Inc.

(21) Appl. No.: 12/469,502

(22) Filed: May 20, 2009

Related U.S. Application Data
(60) Provisional application No. 61/054,730, filed on May 20, 2008.
(60) Provisional application No. 61/073,157, filed on Jun. 17, 2008.

(51) Int. Cl. G09B 5/00

(52) U.S. Cl. 434/350

(57) ABSTRACT

A computer system that may, for example, be used for educational purposes delivers content, e.g., instructional content, to a plurality of users, e.g., students. The content is presented to such users in units, e.g., learning units. Each unit has associated with it an assessment information relating to each one of the users. One or more systems, e.g., learning systems, present the one or more units to one or more users in a first interactive environment, e.g., a first learning environment, and a second interactive environment, e.g., a second learning environment, that is different from the first interactive environment. A digital rights and asset management application controls access to the content associated with each one of said one or more units according to corresponding unit identifiers, e.g., learning unit identifiers, and presents such content to the plurality of users in the first and second interactive environments for assessment purposes. An assessment application, e.g., a grade book application, stores assessment information derived from presenting the content to said one or more users in the first and second interactive environments, with the unit identifier correlating the assessment information with the units.

### CROSS-REFERENCE TO RELATED APPLICATIONS

This application is related to and claims priority to U.S. provisional patent application No. 61/054,730, filed May 20, 2008, and U.S. provisional application No. 61/073,157, filed Jun. 17, 2008, the corresponding specifications of which are hereby incorporated by reference in their entirety.

### FIELD OF THE INVENTION

This invention relates to the field of educational systems in general and to educational systems that provide various instructional material in various learning environments in particular.

### BACKGROUND OF THE INVENTION

Generally, a learning management system (LMS) is software for delivering, tracking and managing training. LMSs range from systems for managing training records to software for distributing courses over the Internet and offering features for online collaboration. In many instances, LMSs are used to automate record-keeping as well as to register students for classroom and online courses. Self-registration, faculty-led learning, learning workflow, the provision of on-line learning (e.g., read and understand), on-line assessment, management of continuous professional education (CPE), collaborative learning (e.g., application sharing, discussion threads), and learning resource management (e.g., instructors, facilities, equipment), are dimensions to LMSs.

FIG. 1 is a diagram depicting a known LMS 10, including one offered by Blackboard, WebCT, Moodle, eCollege and others, which allows a faculty member to place his or her courses, in whole or in part, online. As depicted, the faculty 12 plays a central role for mediating between a student 13, presenting course content 15 and assessing a student 14. LMSs 10 usually provide all-inclusive learning environments for faculty and students, with the faculty 12 disseminating instructional material specific to a course of study amongst students. As such, the faculty member serves as the facilitator, assessor and content developer.

Digital rights management (DRM) is a generic term that refers to access control technologies that can be used by publishers, copyright holders and individuals to impose limitations on the usage of digital content, including content used in educational systems. The term is used to describe any technology which makes the unauthorized use of such digital content technically formidable. Digital asset management (DAM) is a generic term that refers to delivery control technologies. A known system which combines these two and which is used in educational and training based solutions is offered by ShareStream LLC (www.sharestream.com). ShareStream's system provides audio and video content for streaming media, downloads, and podcasts in a secure Internet environment. Using a system such as this, course content is only accessible to those clients enrolled in the specific course and only through a specific LMS application. Ecollege is an LMS 10 with an accompanying system that provides both DRM and DAM, called Content Manager. It also provides audio and video content, as well as significant text content, within a system that protects the digital rights of the copyright holder. The term Digital Rights and Asset Management (DRAM) as used herein describes systems which combine the two generic capabilities of DRM and DAM. Both eCollege and Sharestream are examples of existing DRAMs.

Electronic grade books are used for recording student assessment information. Usually, a grade book is part of an student information system which is used to record pupils' grades, attendance and other data which is then made available online. One example of a grade book is Apple's PowerSchool software, which allows students and parents to check grades online through the school's unique page on the PowersSchool servers. Infinite Campus (www.infinitecampus.com) also provides an electronic grade book for teachers which posts information for parents and students to see standards-based and conventional grades, assignments, test scores, project documents through a web-browser portal. Still another example is GPA Teacher (www.gpasoftware.com) a web based software that provides an electronic grade book, lesson planner, and methods of posting educational information for parent and student access.

Edline (www.edline.com) also offers an array of technology solutions that support web hosting, content management, information portals, and tools for classroom management, grade book, notification, analytics, virtual storage and related technologies—all of which can be deployed individually or together as part of an integrated and comprehensive Learning Community Management System (LCMS). With Edline's LCMS, teachers can publish secure progress reports, including grades, attendance, missing work, comments, etc., en masse at their teacher pages. The teachers can launch their grade book from the same system with which they manage their lessons or post homework online. Students and parents can participate in online discussions, find practice exercises, complete assessments online, or hand in homework at the same classroom web page where they find personalized reports from the grade book application. Because all of the teachers web pages are deployed as part of the umbrella LCMS, parents can quickly see a consolidated view of calendar information from different classes, teams, or groups, all in a central location.

Conceptually, however, there is no difference between the role of a teacher in conventional LMSs 10 and the role of a teacher in a bricks and mortar classroom. In both cases, the students are grouped and assigned a specific teacher. The teacher introduces all course content and materials into the classroom and mediates and assesses the learning process of the student. Thus, under LMS 10, the web is a tool to replicate, as closely as possible, the traditional classroom environment and the LMS 10 is limited by its system boundaries, just as the physical classroom is limited by four walls and doors.

With advances in content and media delivery technologies, the LMS model has not fully taken advantage of the available features for educating students in various learning environments. These features include podcasting, wikis, blogs, social networks and virtual environments. Conventional LMS developers' attempt in incorporating new features into their existing systems in some cases can result in significant developments cost in redesigning their content to incorporate the functionality of these new technologies. In other cases, the developers may have to open up their system platform through application programming interfaces (API's) to “bolt on” new technological capabilities. LMS redesign investment may be expensive, especially when new development work may not be able to keep up with the proliferation of ever advancing technologies and features. Opening up platforms through APIs may present a significant competitive disadvantage to LMS vendors and service providers who have invested heavily in their proprietary instructional material delivery systems.

Additionally, educational services are increasingly offered over global networks of institutions and universities. For example, Laureate Education Inc., the assignee of the present application, currently offers accredited campus-based and online courses in a wide variety of programs, including undergraduate and graduate degree programs and specializations, to nearly 50,000 students in 20 countries. Such a global educational network requires supporting various learning environments that are tailored to bring to students a global perspective blended with a local point of view, creating a truly multicultural, career-oriented educational experience for students. For example, the educational experience may be a career-focused or licensing program, a multi-year undergraduate degree program, or master's and/or doctorate degree program in any one of a number of fields including engineering, education, business, health care, hospitality, architecture, and information technology, etc. These may be delivered online through any one of several popular LMS's 10, or homegrown LMS's 10, or in classrooms, or in computer labs, or other learning environments.

Thus, a need exists for an educational system that can easily implement advances in learning technology for adaptation in various learning environments in a global network of campus-based and online learning environments.

### SUMMARY

Briefly according to the present invention, a computer system that may for example, be used for educational purposes delivers content, e.g., instructional content, to a plurality of users, e.g., students. The content is presented to such users in units, e.g., learning units. Each unit has associated with it an assessment information relating to each one of the users. One or more systems, e.g., learning systems, present the one or more units to one or more users in a first interactive environment, e.g., a first learning environment, and a second interactive environment, e.g., a second learning environment, that is different from the first interactive environment. A digital rights and asset management application controls access to the content associated with each one of the one or more units according to corresponding unit identifiers, e.g., learning unit identifiers, and presents such content to the plurality of users in the first and second interactive environments for assessment purposes. An assessment application, e.g., a grade book application, stores assessment information derived from presenting the content to the one or more users in the first and second interactive environments, with the unit identifier correlating the assessment information with the units.

According to some of the more detailed features of the invention, at least one of the first or second interactive environments comprises a learning environment, a social networking environment, a public personalized homepage environment, a portal environment, a static standard html webpage environment, a mobile environment or a computer lab environment. The first and second interactive environments allow for a log-in that identifies a user to at least one of the digital rights and asset management application or assessment application. The user can be a facilitator that mediates content to another user of a unit, an assessor that assesses a user, an administrator that administers the one or more systems or a content developer that develops the content.

According to other more detailed features of the invention, the one or more systems comprise a development application allowing the content developer to develop the content for a unit based on a developer profile independent of the facilitator that mediates the content to the user of the unit. Alternatively, the one or more systems comprise an assessment application allowing for the assessor to assess student performance in a learning unit based on an assessor profile independent of a facilitator that mediates the content to a user of the unit. The one or more systems comprise a facilitation application allowing for the facilitator to mediate the content to the user of the unit according to a facilitator profile. The unit can be any one of a course, seminar, class, lecture, homework assignment, test, quiz, lab or task.

According to still other more detailed features of the invention, the assessment application further includes a drop-box application and a communication application for communication with a user. At least one of an administrator, facilitator or developer sets at least one of the digital rights and asset management application or assessment application to allow user access to assessment information from within at least one the first or second interactive environments.

### BRIEF DESCRIPTION OF THE DRAWINGS

The present invention will be more readily understood from the following detailed description when read in conjunction with the accompanying drawings, in which:

FIG. 1 is a diagram depicting the model for a known learning management system (LMS).

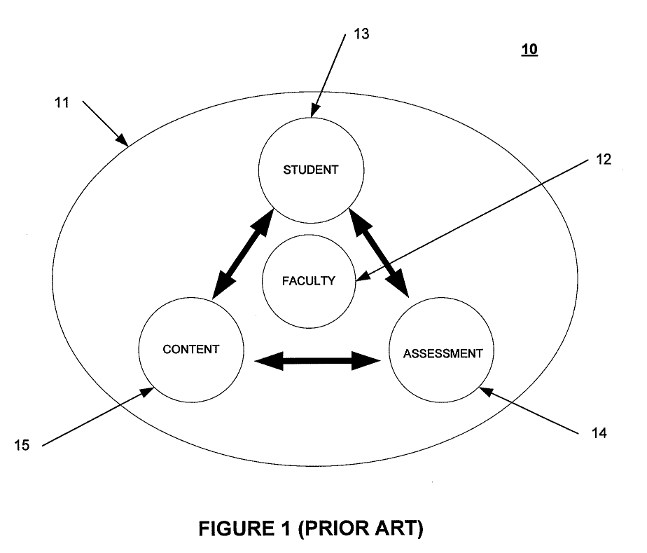

FIG. 2 is a diagram depicting the model for an educational system according to the present invention.

FIG. 3 shows an exemplary block diagram of an online learning system according to an exemplary embodiment of the present invention.

FIG. 4 is a diagram depicting one or more learning systems in the educational system according to an exemplary embodiment of the present invention.

FIG. 5 is a block diagram depicting the relationship between a DRAM and an electronic grade book in the educational system of FIG. 2.

FIG. 6 shows one exemplary client log-in portal for the educational system of FIG. 2.

FIG. 7 shows another exemplary client log-in portal for the educational system of FIG. 2.

FIG. 8 shows still another exemplary client log-in portal for the educational system of FIG. 2.

FIG. 9 shows yet another exemplary client log-in portal for the educational system of FIG. 2.

FIG. 10 shows a student workbook in a hybrid (online and face-to-face) learning environment according to one embodiment of the invention.

FIGS. 11a and 11b show a user interface for accessing the DRAM application on a mobile learning environment according to one embodiment of the invention.

FIG. 12 shows a facilitator module according to one embodiment of the invention.

FIG. 13 shows a facilitator profile according to one embodiment of the invention.

FIG. 14 shows a developer module according to one embodiment of the invention.

FIG. 15 shows a developer profile according to one embodiment of the invention.

FIG. 16 depicts an assessor module according to one embodiment of the invention.

FIG. 17 shows an assessor profile according to one embodiment of the invention.

FIG. 18 shows the student profile according to one embodiment of the invention.

### DETAILED DESCRIPTION

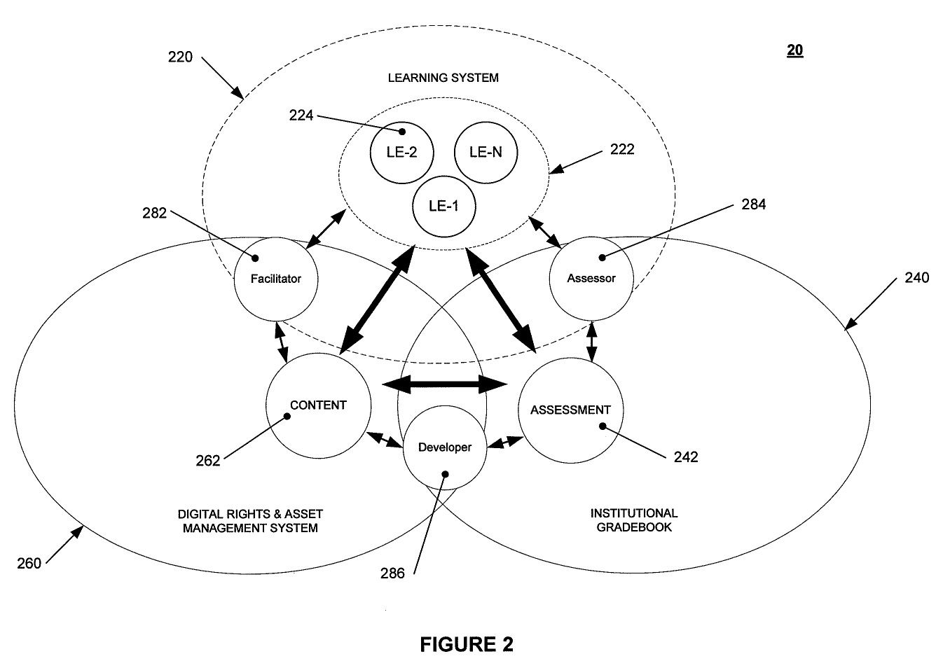

FIG. 2 is a diagram depicting the model for an educational system, or computer system, according to the present invention that presents a plurality of learning environments 222, or interactive environments, to a plurality of students, or users, that are assessed for performance in completed learning units, or units. A learning unit can comprise any unit that is associated with one or more instructional content. A learning unit can be a class, i.e. a period of education such as an hour, day, week, month, semester, quarter, etc. The learning unit can also be a course, seminar, lecture, homework assignment, test, quiz, lab or task. The learning units each have corresponding assessment information associated with each student. Such assessment information can be expressed in any suitable form in the grade book module, for example in terms of student grades, ranking, mark indicating a degree of accomplishment in school, etc.

The educational system, or computer system, of the invention comprises one or more learning systems 220, or systems, for presenting the learning units, or units, to the students in different learning environments 222, or interactive environments. A learning system according to the present invention creates the one or more learning environments 224 over a network, on-line, or in a campus having an administrator for enrolling students for instructional purposes. A network comprises a plurality of privately or publicly connected nodes that are enabled to exchange information over one or more links. Exemplary networks comprise any one or more of WANs, LANs, PANs, Internet or Extranets. The Internet is a collection of interconnected (public and/or private) networks that are linked together by a set of standard protocols to form a global, distributed network. A node comprises one or more units (software or hardware or both) and/or devices located anywhere in the network that processes information and/or performs an attributed function. Examples of nodes include server nodes, client nodes, computer nodes, processing node, communication nodes, work stations, PDAs, mobile devices, data entry node, scheduling node, accounting node, matching node, instructional delivery node, teacher selection node, etc. The nodes can be connected to each other according to any suitable network model, including but not limited to client server models as well as a hierarchical or distribution models. A link comprises any medium over which two nodes may communicate information with each other. Exemplary links include, but are not limited to, wired, fiber, cable, or wireless links. A communication channel comprises any channel used with a link for delivery of learning or instructional material content, or environments to a student.

A learning environment 224 can be created within a learning unit. A learning unit comprises any session during which instructional material is delivered to one or more students. An online learning session means any learning session that takes place over a network. An on-campus learning session comprises any learning session that takes place at a campus. A classroom comprises any environment that allows for interaction amongst a plurality of students with or without a teacher. A learning environment 224 comprises any environment created using instructional content, including learning workspaces, shared whiteboards, reference tools, such as a dictionary, encyclopedia, thesaurus, calculator, games, etc. Instructional content means any material of instructional value used for instructing a student or for assessing a student's skills. Examples of instructional content are any one of work sheets, practice sheets, problem sets, as well instructional audio, video, text, image, lectures, briefs, papers, software, environment, simulation, interface, content, presentations, documents, media files, test material, etc. Electronic instructional content comprises any instructional material that is delivered over a network. Exemplary electronic instructional materials comprise any instructional material delivered via electronic student or teacher workbooks.

The educational system of the present invention creates different learning environments 222 that vary in terms of students' learning experiences. Hence, the educational system of the present invention is referred to as a Variable Learning Environment (VLE) 20. While an LMS, such as Blackboard®, e-College®, etc., which are learning environments 224 in their own right, can be one of the different learning environments 222 within the VLE 20, unlike the LMS 10, the VLE 20 can accommodate and manage a plurality of different learning environments 222 that are tailored for various educational networks, institutions, schools, universities, with each learning environment 224 having different attributes in terms of faculty, instructional content, geography, technology, assessment criteria, etc. A learning environment 224 may comprise a LMS (for example, Blackboard®, E-College® or Moodle®), a public personalized homepage (for example, MyYahoo®, iGoogle® or PageFlakes®), a social network (such as Facebook®, MySpace® or LinkedIn®), professional or academic portals (such as Campus Cruiser®, MS Exchange with Sharepoint®, Sunguard's Luminis Portal® and Gmail®), a static standard html website, or a computer lab. Another learning environment 224 that can be implemented according to the present invention is a mobile learning environment. E-books such as Amazon's Kindle® are becoming popular with the student community. A learning environment 224 using e-books can be used for presenting instructional content and assessment information to students according to the present invention. The same or different learning units can be presented in the different learning environments 222, for example, on-line, on-campus or a hybrid of both, whether locally, regionally or globally.

The one or more learning systems 220 that create the different learning environments 222 of the VLE 20 allow the same student to have substantially the same learning experiences in each learning environment 224. Additionally, different students can have substantially the same learning experiences in the VLE 20 of the present invention. Within a single learning system 220, a student may access any number of different learning environments 222. For example, a student may access a first learning environment 224, such as E-College, while on campus to complete and submit a homework assignment, and then a second learning environment 224, such as Facebook, at home to review course material.

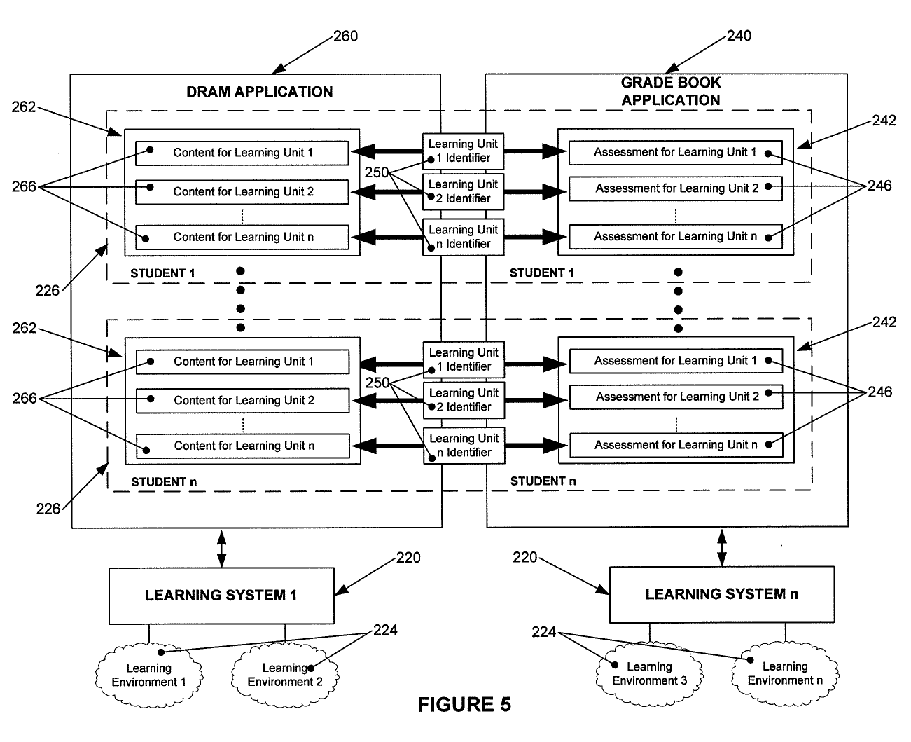

The VLE 20 as implemented according to the present invention further includes a digital rights and asset management system (DRAM) application 260 and a grade book application 240. The DRAM application 260 controls access to instructional content 266 (as shown in FIG. 5) associated with the learning units according to corresponding user access privileges. A user can be a student, a teacher, a faculty, an assessor, a facilitator, a content developer, etc. Each such user can have a user profile that stores such user's attributes and privileges with respect to the learning units, instructional content, access to databases, etc. Each leaning unit also has a learning unit identifier (LUI) 250 (shown in FIG. 5) which is used for presenting instructional content 266 to students in the different learning environments 222 via the one or more learning systems. The grade book application 240 stores student assessment information 246 (see FIG. 5) derived from presenting the instructional content 266 to the students in the different learning environments 222, with the learning unit identifier 250 correlating the assessment information 242 of the students in the grade book application 240 with instructional content 266 associated with each of the learning units in the DRAM application 260.

In one implementation, depicted in FIG. 2 by the arrows, the VLE 20 separates the functions of the faculty 282, assessor 284 and instructional content developer 286. Under this implementation, instructional content 266 can be developed under the control of the DRAM 260 independent from the way in which the faculty, who acts as a facilitator 282, mediates such content to the students of each learning unit. Similarly, the function of assessing the students can be made independent of the facilitator 282 or developer 286 functions such that an assessor 284 can assess the students of the learning unit without the facilitator 282 or developer 286 involved. An assessor 284 can enter the student assessment information 246 into the grade book application 240 in such a way that the assessment information 246 is correlated with the learning units associated with each student based on learning unit identifiers 250, as further described below. This arrangement allows for modular implementation of the present invention within the different learning environments 222, thereby allowing for implementation of advances in the educational field at low cost without the need for overhauling the system for integrating such advanced features into the educational system.

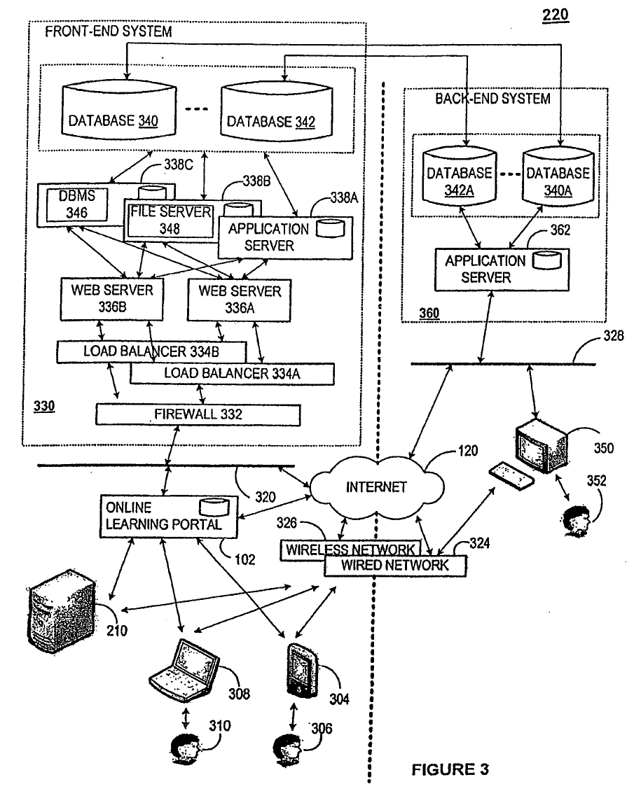

FIG. 3 shows an exemplary block diagram of an online learning system 220 according to an exemplary embodiment of the present invention. Some of the functions of the online learning system 220 include establishing online learning sessions, development and delivery of electronic instructional material and content 266 under the control of the DRAM application 260, creating a plurality of different learning environments for students, and storing and analyzing information under the control of the grade book application. According to this embodiment, the online learning system 220 includes a front-end system 330 and a back-end system 360. The front-end system 330 provides user interfaces to students, teachers/faculty, facilitators, assessors, or other users, e.g., parents, for access to online learning sessions. The back-end system 360 is used for system administration, instructional material and content development and implementation, assessment information record keeping, as well as application developments for billing, marketing, public relations, etc.

The front-end system 330 interfaces with the user devices 304, 308, allowing users 306, 310 to interface with different virtual learning environments. Users 306, 310 include teachers, faculty members, facilitators, students, assessors, responsible authorities, directors, etc. The front-end system 330 provides users 306, 310 interactive access to online sessions. The user devices 304, 308, and/or a plurality of learning center servers 210 are coupled to the online learning portal 102 via a network 320, which may be a LAN, WAN, or other local network. The online learning portal 102 acts as a gateway between the front-end system 330, the user devices 304, 308, and a plurality of learning centers via corresponding learning center servers 210. Alternatively, the user devices 304, 308, and/or learning center servers 210 may be coupled to the online learning portal 102 via the Internet 120 or through a wired network 324 and/or a wireless network 326.

In an exemplary embodiment, the user devices 304, 308 execute a network access application, such as a browser or any other suitable application or applet, for accessing the front-end system 330. The users 306, 310 may be required to go through a log-in session before engaging in an online learning session through the website. Other arrangements that do not require a log-in session may also be provided in accordance with other exemplary embodiments of the invention.

In the exemplary embodiment shown in FIG. 3, the front-end system 330 includes a firewall 332, which is coupled to one or more load balancers 334a, 334b. Load balancers 334a-b are in turn coupled to one or more web servers 336a-b. To provide online learning sessions, the web servers 336a-b are coupled to one or more application servers 338a-c, each of which includes and/or accesses one or more front-end databases 340, 342, which may be central or distributed databases. The application servers serve the DRAM and grade book applications according to the present invention. The application servers also serve various modules used for interaction between the different users of the learning system, including running a facilitator module, a developer module and an assessor module. The facilitator modules allow a facilitator to interact with the learning system for mediating instructional content to the students in the learning units. The developer module allows developers to develop instructional content for the learning units. The assessor module allows assessors to assess student performance. These modules are run independent of each other based on corresponding user profiles, including facilitator, developer, assessor profiles, as further described below.

Web servers 336a-b provide various users portals, including student, facilitator, developer and assessor portals. The servers 336a-b are coupled to load balancers 334a-b, which perform load balancing functions for providing optimum online session performance by transferring client user requests to one or more of the application servers 338a-c according to a series of semantics and/or rules. The application servers 338a-c may include a database management system (DBMS) 346 and/or a file server 348, which manage access to one or more databases 340, 342, including instructional content database of the DRAM and assessment information database of the grade book application. In the exemplary embodiment depicted in FIG. 3, the application servers 338a and/or 338b provide instructional content to the users 306, 310 which include electronic interfaces, instructional material, grade books, student profile, faculty profile, assessor profile, developer profile, as well as learning unit identifiers used for correlating instructional content associated with the learning units and student assessment information processed by the grade book application. Some of the instructional content is generated via code stored either on the application servers 338a and/or 338b, while some other information and content, such as student profiles, instructional material, teacher schedule, or other information, which is presented dynamically to the user, is retrieved along with the necessary data from the databases 340, 342 via application server 338c. The application server 338b may also provide users 302, 306 access to executable files which can be downloaded and installed on user devices 304, 308 for creating an appropriate learning environment, with branding and or marketing features that are tailored for a particular application, client or customer.

The central or distributed database 340, 342, stores, among other things, the web content and instructional material deliverable to the students. The database 340, 342 also stores retrievable information relating to or associated with students, teachers, responsible authorities, parents learning centers, profiles (student, facilitator, teacher, faculty, developer, assessor, etc.), billing information, schedules, statistical data, attendance data, enrollment data, teacher attributes, student attributes, historical data, demographic data, compliance data, certification data, billing rules, third party contract rules, educational district requirements, etc. Any or all of the foregoing data can be processed and associated as necessary for achieving a desired learning objective or a business objective associated with operating the system of the present invention.

Updated program code and data are transferred from the back-end system 360 to the front-end system 330 to synchronize data between databases 340, 342 of the front-end system and databases 340a, 342a of the back-end system. Further, web servers 336a, 336b, which may be coupled to application servers 338a-c, may also be updated periodically via the same process. The back-end system 360 interfaces with a user device 350 such as a workstation, enabling interactive access for a system user 352, who may be, for example, a developer or a system administrator. The workstation 350 is coupled to the back-end system 360 via a local network 328. Alternatively, the workstation 350 may be coupled to the back-end system 360 via the Internet 120 through the wired network 324 and/or the wireless network 326.

The back-end system 360 includes an application server 362, which may also include a file server or a database management system (DBMS). The application server 362 allows a user 352 to develop or modify application code or update other data, e.g., electronic content and electronic instructional material, in databases 340a, 342a.

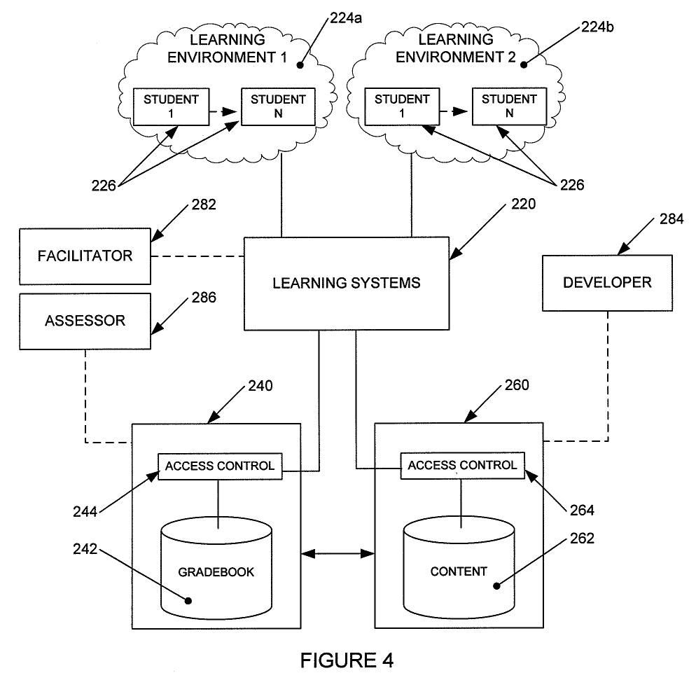

Referring to FIG. 4, one or more learning systems 220 presents two or more different learning environments 224a, 224b to students attending corresponding learning units. In one embodiment, a first learning environment 224a may be an LMS, e.g., Blackboard®, and the second learning environment 224b may be a portal, such as iGoogle®, Facebook®, etc. The different learning environments 224a, 224b interface via the one or more learning systems 220 with the DRAM application 260 and grade book application 240. In one embodiment, access to the DRAM application 260 and grade book application 240 are under the control of corresponding access control modules 264, 244 that respectively controls access to at least one DRAM content database 262 and at least one assessment database 242 in the DRAM application 260 and the grade book application 240. In the VLE 20 of FIG. 3, the DRAM application 260 and grade book application 240 also interface with each other for correlating assessment information 246 with the instructional content 266 associated with the learning units based on the corresponding learning unit identifiers. As stated above, the VLE 20 allows for separate entities to assume the roles of facilitator 282, assessor 284 and developer 286 who interface with the learning system for accessing the DRAM application 260 for instructional content management and for accessing the grade book application 240 for managing assessment information. Unlike the LMS 10, the VLE 20 according to the present invention is not defined by any specific learning management system or specific learning environment, and the learning system is no longer limited to its own internal applications.

In one embodiment, a learning environment 224 may be a professional or academic portal which, independent of the VLE, provides students with on-demand campus communication, collaboration and learning management tools, including email and calendaring, community building for academic collaboration, announcements, forums and chat/messaging, survey tools, photo albums and shared files, online journal and academic networking. In another embodiment, the learning environment 224 may be a social network providing a web link to the learning system, DRAMS application 260 and/or grade book application 240. In yet another embodiment, a learning environment 224 may further include one of an online learning environment, a mobile learning environment, a live (or face-to-face) computer lab learning environment, in-campus environment, class room environment or a hybrid or combinations of such learning environments. For example, if a professor, who usually holds a live-class session twice a week, is called out of town on business the professor may instruct his class to view the class sessions that week on a social network, such as Facebook®, rather than cancel class or schedule a make-up session.

The DRAM application 260 stores and serves digital content 266 to students with authenticated content rights. Unlike content databases used in conventional LMSs 10, the DRAM application 260 in the VLE 20 according to the present invention is not a component integrated within the learning system but rather acts as a separate and independent module that serves instructional content 266 into the different learning environments 222 via one or more learning systems 220 that create such environments. Thus, content delivery of instructional material 266 to students is separated from the learning system 220 and the learning environment 224 itself. Stated another way, whereas instructional content 266 stored in a LMS 10 can only play in the LMS 10, the DRAM application 260 in the VLE 20 according to the present invention may present instructional content 266 at any learning environment 224 of any learning system 220.

In one embodiment, an administrator of a school, university or institution may decide to deliver a classroom in a number of different learning environments 222, for example, on the LMS environment, a social networking environment, a mobile environment, etc. Accordingly, the DRAM application 260 is set up to present instructional content 266 in the selected learning environments 224 for students to access, for example, an LMS, an HTML webpage or social network. Similarly, an administrator may grant a privilege to the facilitator 282 thus allowing the facilitator 282 to decide which learning environment to drop the DRAM application 260 into, taking into consideration which learning environments 224 would best suit his/her students' needs. However, the DRAM application 260 limits access rights to those students registered to a particular course within a particular learning system 220. The assessment information 246 can then be accessed via the grade book application 240 according to the present invention from any one of the learning environments 224 provided that the grade book is set up for allowing access to the grade book application 240 from that environment by correlating the LUIs 250 between the DRAM application 260 and the grade book application 240.

The DRAM application 260 may provide digital medial asset management platforms, as well as streaming, downloading and podcasting media and digital content services. The DRAM application 260 may be written to support defined APIs allowing the DRAM application 260 to interface with any number of other applications that facilitate the learning process. The APIs may be updated from time to time to support other applications modules, including educational and media modules that facilitate educational content delivery and student assessment. The DRAM application 260 includes a content database 262 which stores content objects 266, as well as metadata, descriptors, ownership identification (i.e. copyright information) and rights limitations. The content objects 266 in the DRAM application 260 correspond to learning units to be presented to a student in the learning environment 224. A learning unit may be a course, a class, a seminar, a lecture, a learning task or a lesson segment. The content objects 266 may include audio, video, text, images or multimedia data objects. For example, a learning unit (task 2 in week 1 of a course) may link to a stream-lined video for the student to view for homework.

The DRAM application 260 further utilizes high-level user-credential verification checking, an integration capability with the educational institution's preexisting IT infrastructure through proprietary middleware, worldwide content distraction capability through secure streamed media, and downloads and podcasts to PCs, handhelds, and MP3 players. The high-level user-credential verification checking capability allows universities or learning systems to distribute digital content both on-campus and off-campus in a manner keeping with current legal standards. The DRAM application 260 interacts seamlessly with the learning system's 220 data services and learning environment 224, resulting in a hassle-free workflow, beginning with encoding (digital content creation) and culminating in secure delivery of content to verified end-users throughout the world. Further the DRAM application 260 eliminates the need to install application software, new versions or updates at multiples sites, for example, different buildings or workstations. The DRAM application 260 further offers legal, piracy-protected handling of copyrighted content; recognizing that the VLE's distribution of digital content is significantly impeded by concerns for piracy of content as well as by issues of compliance with the legal framework surrounding digital distribution of content for educational purposes. The high-level user-credential verification checking capability allows universities or learning systems to distribute digital content both on campus and beyond in a manner keeping with current legal standards. The DRAM application 260 allows students to access digital content in a familiar, centralized learning environment.

The grade book application 240 of the VLE 20 tracks, manages and archives all assessment information 246 and grades relating to the student. As stated above, the grade book application 240 includes an assessment database 242 that stores assessment information 246 relating to the student, formative grades, final grades, courses, sections, faculty and/or grading rubrics. The grade book application 240 may accommodate any learning system's 220 grading system (skills-based, letter grades or numerical) and any grading rubric preferences. Customized weighting, grading symbols, grade scales, attendance codes and other options meet every personal or school requirement. Similar to DRAM application 260, the grade book application 240 may integrate with any learning system 220, corresponding to a particular learning environment 224. Further, the grade book application 240 eliminates the need to install application software, new versions or updates at multiples sites, for example, different buildings or workstations. The grade book application 240 may automatically update grade book files as rosters and student information changes. The grade book application 240 can bring up the most current assessment information 246 for any student from any computer on a network within a learning system 220 associated with the VLE 20. Further, the grade book application 240 offers an automatic backup module to allow an assessor 284 to review previous assessment data.

In one embodiment, students may take online quizzes or tests that are automatically scored and entered into the grade book application 240. This capability may be provided by third-party assessment or testing engines accessed through an API. Or, it may be built as a proprietary application that interfaces with the grade book application, or both. Accordingly, the grade book application 240 may have grade book APIs that support any number of test and assessment schemes that are suitable for a particularly learning unit or learning environment. An instructor or faculty member may administer assessment material and enter the results into the grade book application 240 manually or automatically.

Unlike the LMS 10 where a single faculty member 12 serves the central role in providing instruction to, and assessment of, a student, in the VLE 20 the roles of facilitator 282, assessor 284 and developer 286 can be distinct and independent from each other. In the VLE, the facilitator 282 mediates between the course content 266 from the DRAM application 260 and the learning system 220 delivered to a student in a learning environment 224. This mediation would be accomplished through the native components of a portal such as blogs or discussion groups, or it could be accomplished in a face to face environment like a computer lab. The assessor 284, having access to both the grade book application 240 and learning environment application 224, offers objective assessments assuring that the student assessment is valid. The developer 286, having been given proper access designs the course content 266, creates content objects and learning frames in the DRAM application 260 and creates the associated assessments in the grade book application 240. Further, under the VLE 20 three separate faculty members may take the roles of facilitator 282, assessor 284 and developer 286, or a single faculty member may assume all three roles. Alternatively, an outside consultant, administrator, third party (such as an independent board of evaluators) or software program may assume one or all of these three roles.

Referring to FIG. 5, a block diagram shows the interface between the DRAM application 260 and the grade book application 240 as it relates to the correlation between the instructional content 266 associated with the learning units and the student assessment information 246 associated with each such unit for each student. One or more learning systems 220 that create a plurality of different learning environments 224 interface with a block that contains the DRAM application 260 and the grade book application 240. The instructional content 266 in the content stored in corresponding content databases 262 of the DRAM application 260 are organized by learning units that correspond to the stored content 266. As stated above, a course developer 286, for example, of a business can associate various content 266 in one or more formats, i.e., video, text, image, audio, power point presentation, etc., with one or more learning units associated with the course, e.g., week 1 of the course, with such content being presented to the students in the course under the control of the DRAM application 260. Each learning unit can have a learning unit identifier 250 identifying the unit in any suitable format, e.g., BIZ01-WK-1, LU1, etc. Logically, such learning units are associated with students who are enrolled, registered or otherwise attending learning sessions associated with such learning units. Physically, however, various separate databases, applications and/or process can in a well known manner associate learning unit content 266 with student and learning unit identifier 250. Upon assessment of student performance, for example, by an assessor 284, who may or may not be a facilitator 282, faculty or teacher, assessment information 246 associated with the students are correlated with the learning units based on the learning unit identifier 250 and students in any one the different learning environments 224. In this way, a modular educational system can be created having the DRAM application 260 and grade book application 240 at its core to allow for adaptability and expandability of the students' learning experience as new and more advanced learning environment interfaces, e.g., widgets, portals, modules, applications, etc. are developed and incorporated.

In an embodiment, a student in a learning environment 224 may request access to the DRAM application 260 and/or grade book application 240. An access control 264, 244 verifies the student's registration and standing in the learning system before granting access to instructional content 266 and/or assessment data 246. When the student requests instructional content 266 related to a particular learning unit, a learning unit identifier 250 is relayed to the content database 262 of the DRAM application 260. Based on the learning unit identifier 250 the identified instructional content 266 is presented within the student's learning environment 224. The learning unit identifier 250 further correlates the instructional content 266 with the assessment data 246 received upon the student's completion of the identified learning unit. Thus, after presentation of the instructional content 266 to the student, the student may request assessment data 246 related to that completed learning unit from the grade book application 240. The learning unit identifier 250 is relayed to the assessment database 242 of the grade book application 240. Based on the learning unit identifier 250 the related assessment data 246 is then presented to the student at his/her learning environment 224.

In one embodiment, three different students may receive the same course content 266, but in different learning environments 224 and through varying universities and degree programs. All content 266, identified with at least one learning unit, may be delivered from the same DRAM application 260. Similarly all student assessments may occur under the same grading rubric, with some grades coming from quizzes, some from faculty assigning grades, some from papers and some from class participation. All student assessments are documented, stored and available to the student and to the university.

In another embodiment, the same student may receive course content 266 in two or more different learning environments 224 through the same university degree program. All content 266, identified with at least one learning unit, may be delivered from the same DRAM application 260. Further, the DRAM application 260 will present the instructional content 266 to the student in an identical manner in each different learning environment 224. Thus, a student may choose which learning environment 224 best suits his/her needs at any given time and still receive the same high quality education.

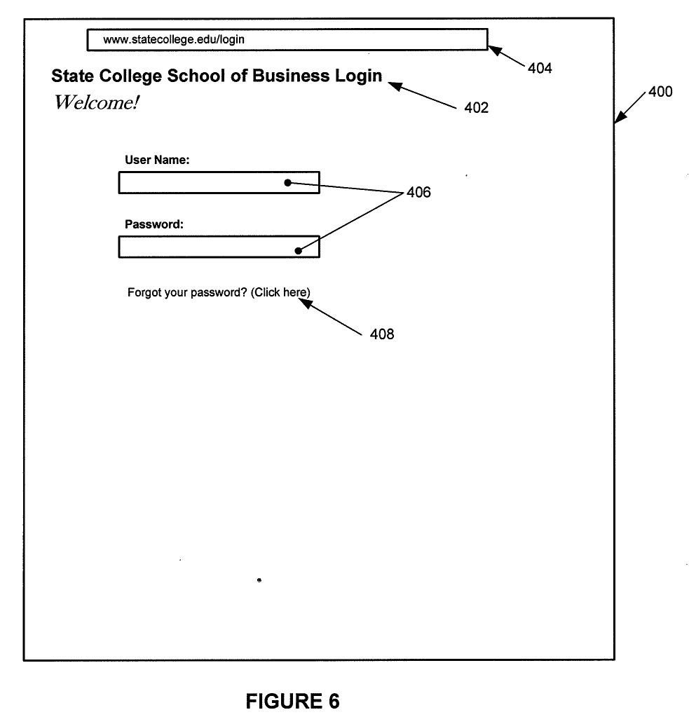

FIG. 6 shows an exemplary client log-in portal 400 according to one embodiment of the invention. In this embodiment, a client, which may be any user referenced above, may log into the VLE 20 by accessing a log-in portal 400 through a learning environment 224, i.e. the State College School of Business academic portal. In this embodiment, the log-in portal 400 identifies the learning system 220 or educational institution 402 at the top of the screen. The log-in portal 400 is accessed by the student either through a link from a main learning system webpage (not shown) or by typing in an address into the web address line 404 of a web browser. At the log-in portal 400 a student is asked to supply a user identifier 406 (such as name and password). The user identifier 406 recognizes whether the student is registered within the learning system 220 to allow access to the student's personalized learning environment 224. Further, the user identifier 406 authenticates content rights in the DRAM application 260 and/or grants access rights to assessment records in the grade book application 240. Thus, the single log-in grants all student rights to the learning environment 224, DRAM application 260 and grade book application 240 of the VLE 20 simultaneously. The log-in portal 400 further includes a help link 408 for a student to click if the student has forgotten his/her user identifier 406.

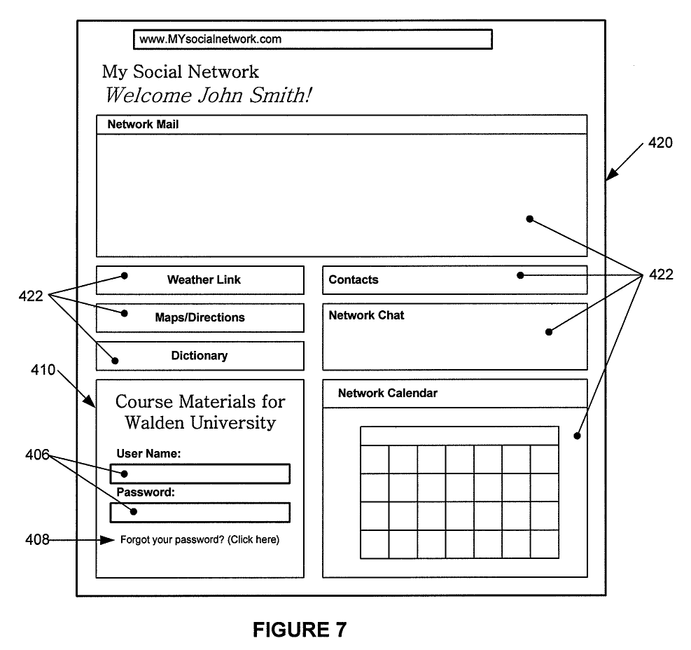

FIG. 7 shows an alternative client log-in method according to another embodiment of the invention. In this embodiment, the student logs into a social networking learning environment 224, i.e. My Social Network 420. The learning environment 224, My Social Network 420, provides a separate log-in link 410 to course materials 266 in the DRAM application 260, while allowing the student to take advantage of other social networking features 422, e.g., contact book, e-mail, or chat with friends, etc. Under this arrangement, the student is asked to supply a user identifier 460 (such as name and password) in the DRAM log-in link 410. Thus, in this embodiment, a log-in portal (not shown) grants the student access rights only to the social networking portal. A separate log-in link 410 for the DRAM application 260 grants access rights to the DRAM application 260. In this embodiment, authenticated access rights to the DRAM application 260 grants further access rights to the grade book application 240. Thus, access to the grade book exists through the DRAM application 260. The log-in portal 410 further includes a help link 408 for a student to click if he/she has forgotten his/her user identifier.

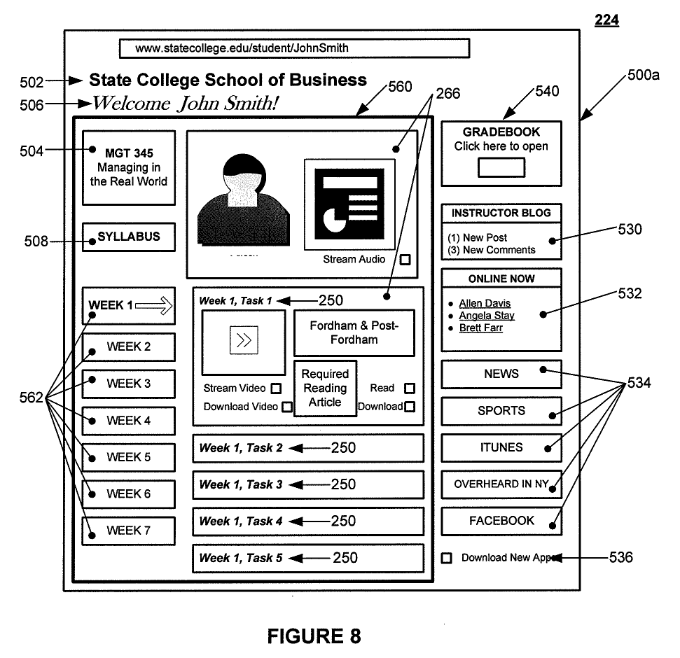

FIG. 8 shows an online learning environment 224 according to one embodiment of the invention. The learning environment 224, an academic portal 500a personalized to the student, may identify the name of the educational institution/program 502, the enrolled course 504 and the name of the student 506. In the present embodiment, the student may select from a variety of learning tools provided through his/her student workbook. For example, the student may listen to or watch either a live or archived course lecture by clicking the stream audio/video button on his/her screen. Similarly, the student may view the expectations of the course instructor by selecting the online syllabus 508.

The student may choose to view course material 266 or assignments week by week, or task by task via learning units via the DRAM application link 560, accessed by the clearly marked learning unit buttons 562 along the left-hand side of the portal. When a student clicks a button 562 for a particular learning unit, a learning unit identifier 250 particular to that assignment or task is sent to the external DRAM application 260, the student's rights are authenticated and the content 266 is presented into the student's learning environment 224, i.e. the academic portal 500a. All instructional content 266 presented to the student via the DRAM application 260 will be presented in the same fashion, regardless of in which learning environment 224 the student requests the content 266. Thus, the instructional content presentation to the student will be the same regardless of whether the learning environment 224 is online, live, or a combination of online and live, and regardless of whether the learning environment 224 is accessed through the student's laptop, e-book or hand-held device.

In this embodiment, the student has requested the instructional content 266 for learning unit identifier 250 “Week 1, Task 1.” As shown, the DRAM application 260 has presented a video and a required reading article into the student's learning environment 224. The student may have the option to stream or download all video and audio for the week or make choices as he/she goes. Or, with regard to reading assignments, a student may choose to read now, download or print. Further, the student may subscribe to the readings, which will subsequently be delivered to the student weekly.

Furthermore, the student may access instructions, posts and comments from the course instructor (or facilitator 282) via the Instructor Blog application 530, which is not connected to the DRAM or grade book applications 260, 240, but is natively available in the portal 500a. Such student may simultaneously engage in live-time chat or discussion with his/her peers through an Online Now application 532 (or chat room) which displays which of the student's colleagues are currently available in their learning environments 224. In another embodiment, links 534 to news, sports, i-tunes®, blogs, Facebook® and/or other web pages may be added to a student's learning environment 224 by the student him- or herself using the “download new apps” application 536. In another embodiment, these same applications are developed as applications proprietary to the system. They are in any case, however, not required components, but may be used only when desired as an option.

Last, a link to the student's personal grade book 540 through the grade book application 240 may be accessed through the student's learning environment 224. A student may click on a link to a completed assignment or task, identified as a learning unit, within the grade book (not shown) to see his/her grade or mark on that project. A learning unit identifier 250 is relayed back to the grade book application 240, where the application authenticates the student's access rights, gathers assessment data 246 related to the learning unit identifier 250, and presents the assessment data 246 at the student's learning environment 224. The assessment data 246 may include the course grading rubric, as well as the student's personal grades and teacher comments on assignments, tests and quizzes.

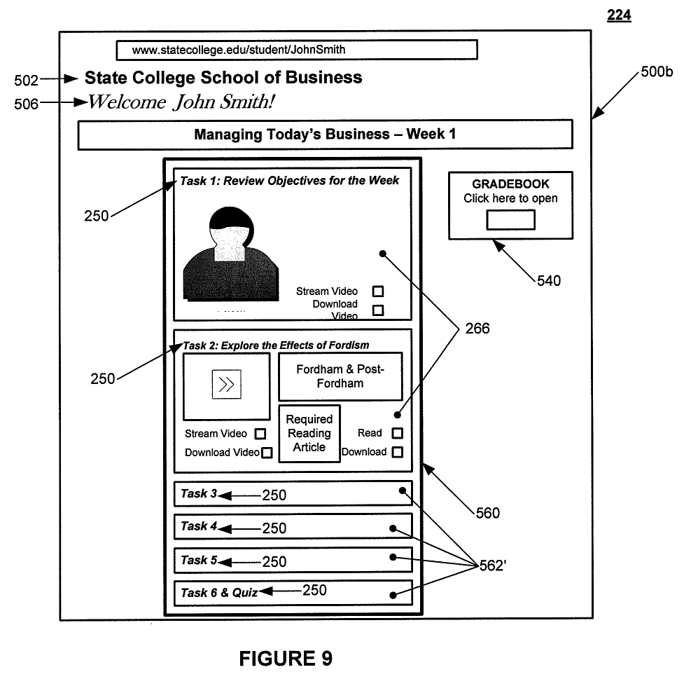

FIG. 9 shows a student workbook 500b in a live (or face-to-face) learning environment 224 according to one embodiment of the invention. A live learning environment 224 most likely occurs in the context of a computer lab, where the instructor gives the class a brief talk and then leads the students in discussing the lesson from the last class session. In this embodiment, a student sits in front of any open computer and logs into a secure academic website to access his/her learning environment. In closing the discussion, the instructor may direct the students to work on various course material related to the particular learning unit previously under discussion.

The learning environment 224 in this embodiment is limited to a link to the DRAM application 260 and the grade book application 240. When a student clicks a content tab 562′ for a particular learning unit, a learning unit identifier 250 particular to that assignment or task is sent to the external DRAM application 260, the student's rights are authenticated and the instructional content 266 is presented in the student's learning environment 224, i.e. the academic website within the computer lab 500b. In this embodiment, the student has requested the instructional content 266 for two learning unit identifiers 250 “Week 1, Task 1” and “Week 1, Task 2.” As shown, the DRAM application 260 has presented a video into the student's learning environment 224 for task 1 and a video and required reading article into the student's learning environment 224 for task 2. A student may put on headphones and work through instructional content 266 related to the identified learning unit. All media is delivered to the student on a high-resolution screen.

Additionally, the student may access his/her grade book by clicking the grade book application link 540 at the top right of the workbook 500b. Within the grade book (not shown), a student may click on a link to a completed assignment or task, identified as a learning unit, to see his/her grade or mark on that project. A learning unit identifier 250 is relayed back to the grade book, where the application authenticates the student's access rights, gathers assessment data 246 related to the learning unit identifier 250, and presents the assessment data 246 at the student's learning environment 224. The student may view his/her in-class participation grade, as well as his/her term paper and quiz grades. Similarly the student may access his/her overall grade for the course.

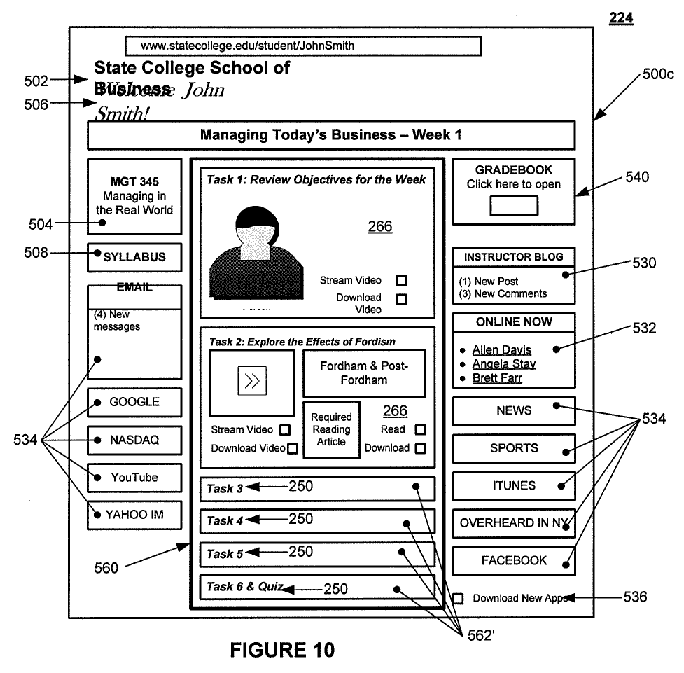

FIG. 10 shows a student workbook 500c in a hybrid (online and face-to-face) learning environment 224 according to one embodiment of the invention. In one embodiment, a hybrid learning environment may be primarily online with several face-to-face meeting times during the semester. For example, an instructor may reserve a face-to-face class session for the class orientation, end of term final, plus four other times for labs and group work clearly posted in the syllabus.

A student in a hybrid learning session 224 may log into an academic portal 500c personalized to the student. In the learning environment 224, the content 266 for the week is identified by learning unit tabs 562′ down the center of the page. When a student clicks a tab 562′ for a particular learning unit, a learning unit identifier 250 particular to that assignment or task is sent to the external DRAM application 260, the student's rights are authenticated and the instructional content 266 is presented at the student's learning environment 224, i.e. the personalized academic portal 500c. In this embodiment, the student has requested the instructional content 266 for two learning unit identifiers 250 “Week 1, Task 1” and “Week 1, Task 2.” As shown, the DRAM application 260 has presented a video into the student's learning environment 224 for task 1 and a video and required reading article into the student's learning environment 224 for task 2.

In another embodiment, optional internet application frames 534, down the sides of the student workbook are selected by the student. The student, for example, could select real-time access to applications 534 such as email, Google®, stock quotes, YouTube®, news feeds, NASDAQ®, Instant Messenger®, etc. To the right of the learning frames is another column of frames including the “Online Now” application 532 and “Instructor Blog” application 530 frames. If a student has a question about a course assignment, he/she may open and read the blog posts and comments listed in the Instructor Blog 530. Alternatively, the student may open a dialog with another student who is indicated as available in the Online Now 532 frame to ask his or her question. While online, the student may check out the other student's profile (not shown), which could provide a work history bio and a home movie of his/her kids. The student may also access the course syllabus 508 to seek additional course information.

Last, the student workbook 500c includes a grade book link 540, where the student may find his/her grades. Within the grade book (not shown), a student may click on a link to a completed assignment or task, identified as a learning unit, to see his/her grade or mark on that project. A learning unit identifier 250 is relayed back to the grade book, where the application authenticates the student's access rights, gathers assessment data 246 related to the learning unit identifier 250, and presents the assessment data 246 at the student's learning environment 224. Grades which are not yet completed may be left blank. In this embodiment, the grade book is managed by the assessor 284, who may be the student's own instructor or an independent third party (such as a evaluation board). The student may access his/her grade book to see the results of all courses he/she has enrolled in at the educational institution. The grade book will be available throughout the student's academic career at this university.

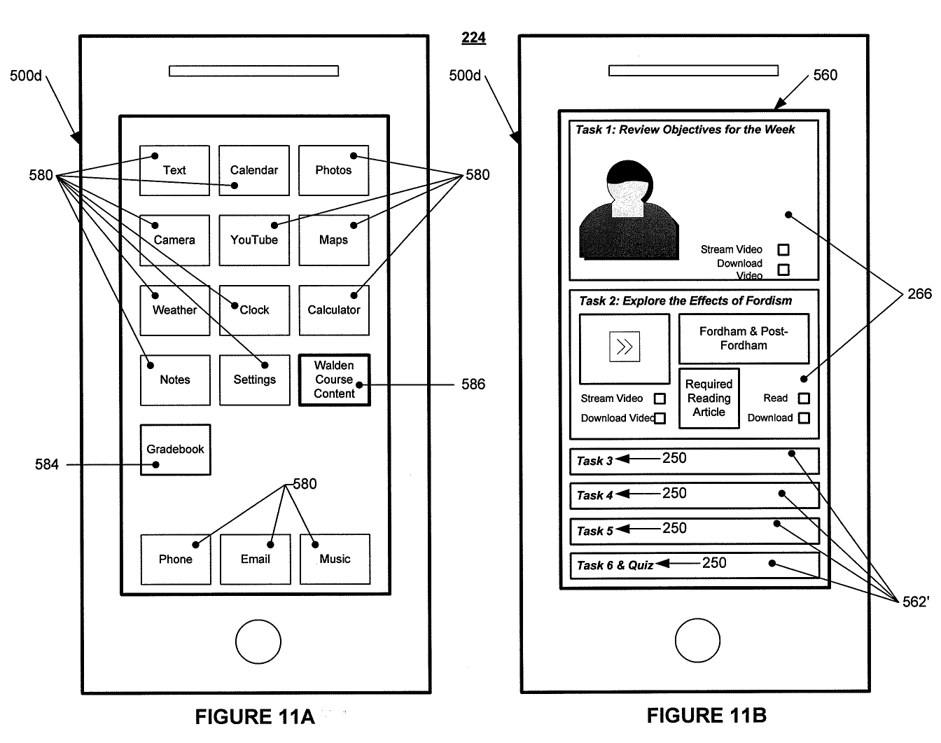

FIGS. 11a and 11b show a user interface for accessing the DRAM application 260 on a mobile learning environment 224 according to one embodiment of the invention. The discussion above, relating to accessing the DRAM application 260 and grade book application 240 through a learning environment 224, also applies to a mobile environment 224 of FIGS. 11a and 11b. A mobile environment 224 may include an e-book, such as Kindle, or a handheld device, such as an iPhone®, Blackberry®, Kindle®, personal digital assistant (PDA), e-Books, or handheld computer.

In the embodiment shown in FIG. 11a, a student's personal mobile phone 500d includes numerous application links 580, including a DRAM application link 586 and a grade book application link 584. If a student clicks on the DRAM application link 586, the student is prompted for his/her user identity 406 (user name and password) which authenticates the student's access and content rights. Once the student has accessed the DRAM application 560, the student may click a tab 562′ for a particular learning unit (e.g., task 1 and 2). A learning unit identifier 250 particular to that assignment or task is sent to the external DRAM application 260, the student's rights are authenticated and the instructional content 266 is presented at the student's learning environment 224, i.e. the student's personal mobile phone 500d. As shown in FIG. 11b, the DRAM application 260 has presented a video into the student's mobile learning environment 224 for task 1 and a video and required reading article into the student's learning environment 224 for task 2.

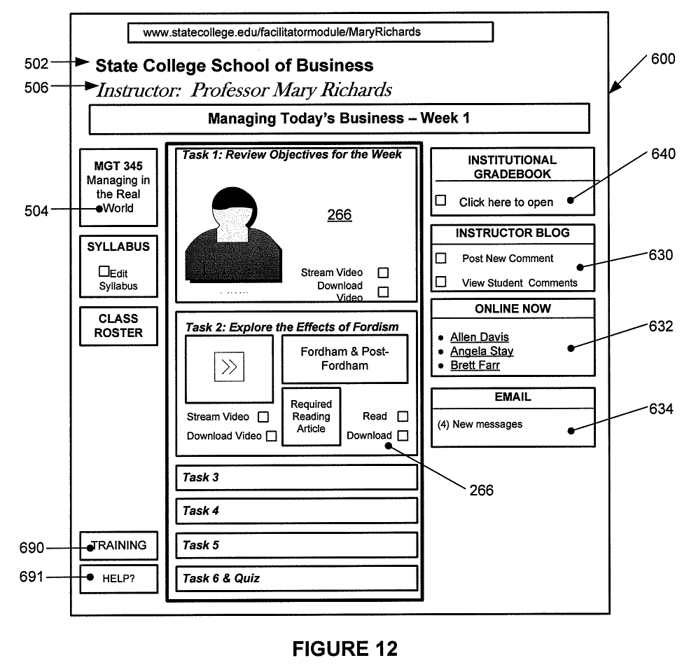

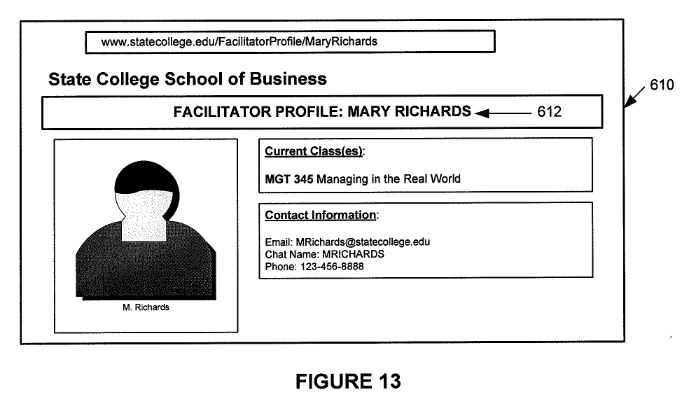

FIG. 12 shows the interface for a facilitator module 600 running in the learning system 220 shown in FIG. 3 according to one embodiment of the invention. The facilitator module 600 includes a facilitator profile 610, as shown in FIG. 13, to grant a particular designated faculty member 612 access to the facilitator module 600 through a log-in portal (similar to FIGS. 6 and 7). Once logged into his/her own personal facilitator module 600, the facilitator 282 may present announcements to his/her students using an Instructor Blog 630 interface designated for a specific course. Similarly, the teacher may chat or email students using the Online Now 632 and email applications 634.

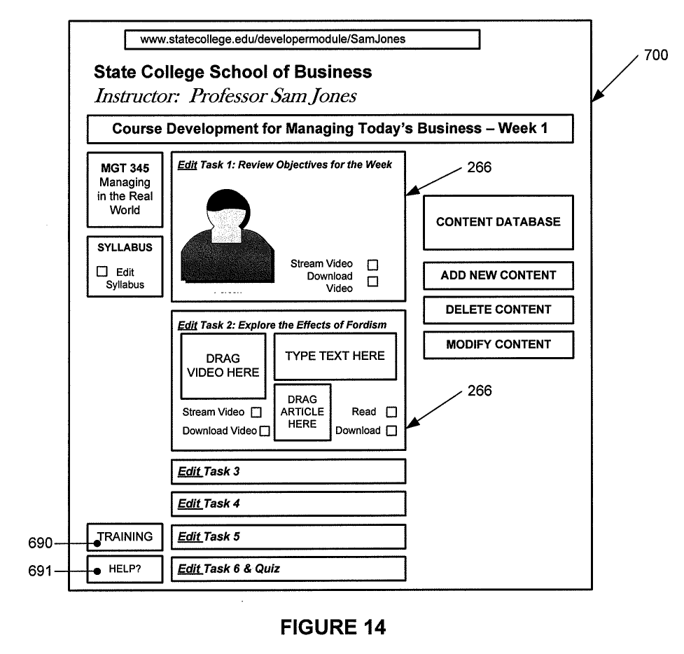

The privileges of the users within each learning system may vary. In the present embodiment, as shown in FIG. 12, a teacher has assumed both the roles of facilitator 282 and assessor 284. Here, the teacher is instructing students based on a pre-defined course with pre-selected course material 266. The teacher does not have the right to change, delete or add instructional content 266. However, the teacher may define his/her own grading rubrics and assessment standards. As seen in FIG. 12, the teacher has access to the grade book application 240 through the facilitator module 600, however the teacher does not have access to an external developer module (see FIG. 14).

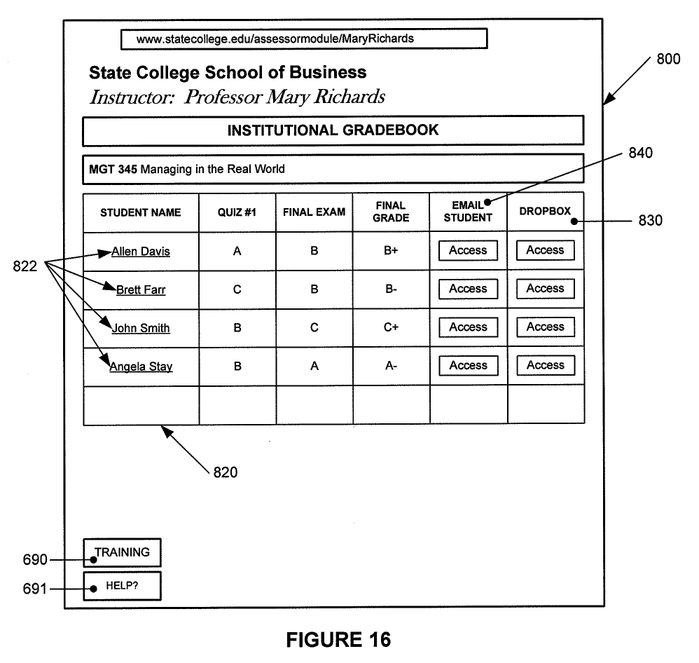

In another embodiment, the teacher may assume the role of facilitator 282, but not developer 286 or assessor 284. Thus, the teacher is instructing students based on a pre-defined course with pre-selected course material 266. Further, the teacher is teaching to the standards of a third-party assessor. The third-party assessor may either grade each student himself/herself or may review the assessment of the facilitator. Therefore, the teacher does not have access to external developer or assessor modules (see FIGS. 14 and 16) through the facilitator workbook 600.

In another embodiment, the teacher may assume both the roles of facilitator 282 and developer 286. Thus, the teacher may select the instructional content 266 for each learning unit himself/herself and may present his/her own course to his students through the student learning environments 224. However, the teacher still must teach and/or grade students to the standards of a third-party assessor and does not have the right to change the grading scheme. Therefore, the teacher does not have access to an external assessor module (see FIG. 16) through the facilitator workbook 600.

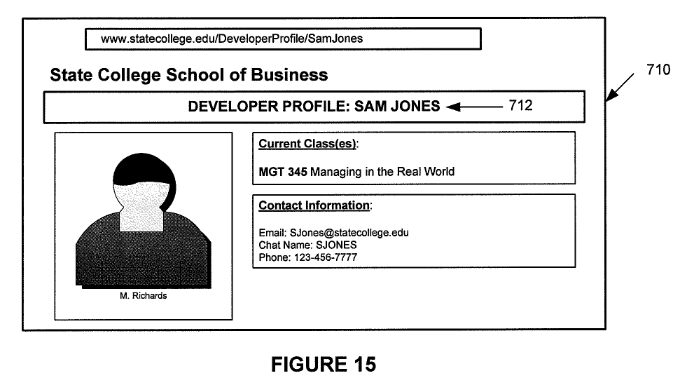

FIG. 14 shows the interface for a developer module 700 running in the learning system 200 shown in FIG. 3 according to one embodiment of the invention. The developer module 700 includes a development profile 710, as shown in FIG. 15, to give flexibility for a teacher or third party independent developer to develop instructional content 266 to be presented to students in different learning environments 224. For example, the developer profile 710 can contain a developer identity field 712 that identifies an authorized developer 286 for a learning unit. Such authorized developer 286, in this embodiment, can also be a facilitator 282 that mediates content between the DRAM application 260 and the learning environment 224.

In yet another embodiment, the teacher may assume the roles of facilitator 282, developer 286 and assessor 284. Thus, the teacher may select the instructional content 266 for each learning unit himself/herself and may present his/her own course to his students through the student learning environments 224. Further, the teacher may define his/her own grading rubrics and assessment terms. Therefore, the teacher has access to both external the developer module 700 and assessor module (see FIG. 16) through his/her facilitator workbook 600.

In another embodiment, more than one person may be assigned to the role of facilitator 282, assessor 284 or developer 286. For example, a particular learning system 220 may implement a team of developers 286 to develop learning units and corresponding instructional content 266.

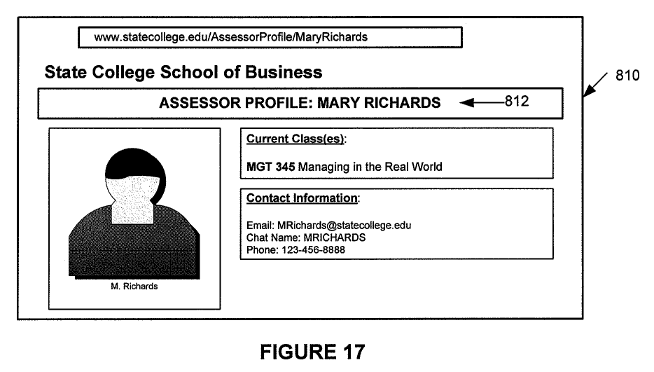

FIG. 16 depicts an assessor module 800 according to one embodiment of the invention. An assessor 284 is granted access to the assessor module 800 through an assessor profile 810, as shown in FIG. 17. Whereas students only see their own grades, the assessor sees a list 820 of all of his/her students, arranged by course and section. Some students' grades will be populated into gray boxes, indicating that they are auto-populated through some other source (for example, an online quiz or high stakes exam).

The assessor module in FIG. 16 includes both a drop box application 830 and a simple communication application 840 within the assessor module 800. This allows communication between the student and the assessor 284 whether or not the learning environment 224 has robust native features for communication, such as blogs or discussion boards. In one embodiment, the grade book application 240 may be accessed by a student or facilitator through a separate secured grade book website available at any computer or workstation with internet access (not shown).

In this embodiment, it is important for the grade book application 240 and DRAM application 260 to be self-contained so that a facilitator 282 may teach a learning unit without anything else. Thus, a drop box application 830 and communication application 840 within the grade book of each student and assessor module 800 is necessary to prevent difficult communication between the teacher and student.

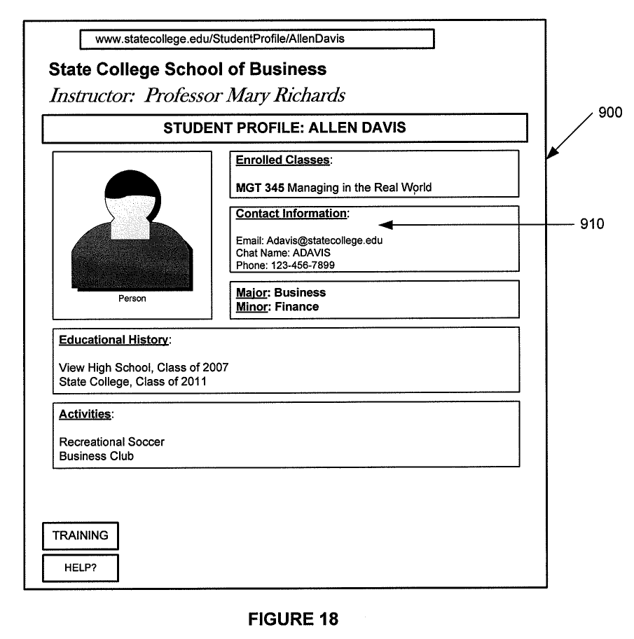

In one embodiment, clicking any student's name 822 in the grade book allows a teacher to see the student's basic profile 900, as shown in FIG. 18, including contact information 910. It is through the assessor module 800 that the teacher provides each student with an evaluation for each activity, whether that activity happened online, in an application such as MySpace®, or in a classroom.

Further, due to the non-complex nature of the teacher workbook under the VLE 20 according to the present invention, little training is required. Faculty may not need any more technical capability than is necessary to log into Blackboard, lead discussions on a discussion board, use a grade book and send and receive email. However, if the teacher workbook utilizes MySpace®, for example, the teacher may require some additional training and tutoring in order to use the MySpace® application. However, the skills necessary to become facile in that environment are not great. The VLE 20 system itself is generally intuitive and user-friendly. A training application 690 and help application 691 included on each of the facilitator module 600, developer module 700 and assessor module 800 (FIGS. 12, 14 and 16) should be sufficient to provide all necessary basic instruction.

In summary, the VLE 20 creates a modular system, integrating the DRAM application 260 and grade book application 240 which allow the VLE 20 to deliver instructional content 266 to students in any learning system 220 and to any learning environment 224, as well as assess each student based on the instructional content 266 delivered. Future development and new applications may be modularized and similarly integrated into any new or existing VLE 20 system. For example, a virtual reality application could be incorporated into an existing VLE 20 and operate in a manner similar to both the existing grade book application 240 and the DRAM application 260.

It will be understood that the above description of the present invention is susceptible to various modifications, changes and adaptations, and that the same are intended to be comprehended within the meaning and range of equivalents of the appended claims.

What is claimed is:

1. An educational system for presenting one or more learning units to a plurality of students, wherein said learning units have corresponding student assessment information associated with each one of said plurality of students, comprising:
one or more learning systems for presenting one or more learning units to one or more students in a first learning environment and a second learning environment that is different from the first learning environment;
a digital rights and asset management application that controls access to instructional content associated with each one of said one or more learning units according to corresponding learning unit identifiers and presents such instructional content to said plurality of students in said first and second learning environments; and
a grade book application that stores student assessment information derived from presenting said instructional content to said one or more students in the first and second learning environments, said learning unit identifier correlating said assessment information with the learning units.

2. The educational system of claim 1, wherein at least one of said first or second learning environments comprises an LMS environment, a social networking environment, a public personalized homepage environment, a portal environment, a static standard html webpage environment, a mobile environment or a computer lab environment.

3. The educational system of claim 1, wherein said first and second learning environments allow for a log-in that identifies a user to at least one of the digital rights and asset management application or grade book application.

4. The educational system of claim 3, wherein said user comprises at least one of a student, facilitator, faculty, an assessor, an administrator or a course developer.

5. The educational system of claim 4, wherein said one or more learning systems comprise a development application allowing said course developer to develop instructional content for a learning unit based on a developer profile independent of a facilitator that mediates instructional content to a student of the learning unit.

6. The educational system of claim 4, wherein said one or more learning systems comprise an assessment application allowing for said assessor to assess student performance in a learning unit based on an assessor profile independent of a facilitator that mediates instructional content to a student of the learning unit.

7. The educational system of claim 4, wherein said one or more learning systems comprise a facilitation application allowing for said facilitator to mediate instructional content to a student of the learning unit according to a facilitator profile.

8. The educational system of claim 1, wherein a learning unit comprises one of a course, seminar, class, lecture, homework assignment, test, quiz, lab or task.

9. The educational system of claim 1, wherein said grade book application further includes a drop-box application and a communication application for communication with a student.

10. The educational system of claim 1, wherein at least one of an administrator, facilitator or developer sets at least one of the digital rights and asset management application or grade book application to allow students access to assessment information in at least one the first or second learning environments.

11. An computer system that delivers content to a plurality of users, the content being present to users in units, each unit having associated therewith an assessment information relating to each one of the users, comprising:
one or more systems for presenting one or more units to one or more users in a first interactive environment and a second interactive environment that is different from the first interactive environment;
a digital rights and asset management application that controls access to the content associated with each one of said one or more units according to corresponding unit identifiers and presents such content to said plurality of users in said first and second interactive environments for assessment purposes; and
an assessment application that stores assessment information derived from presenting said content to said one or more users in the first and second interactive environments, said unit identifier correlating said assessment information with the units.

12. The computer system of claim 11, wherein at least one of said first or second interactive environments comprises a learning environment, a social networking environment, a public personalized homepage environment, a portal environment, a static standard html webpage environment, a mobile environment or a computer lab environment.

13. The computer system of claim 11, wherein said first and second interactive environments allow for a log-in that identifies a user to at least one of the digital rights and asset management application or assessment application.

14. The computer system of claim 13, wherein said user comprises at least one of a facilitator that mediates content to a user of a unit, an assessor that assesses the user, an administrator that administers the one or more systems or a content developer that develops the content.

15. The computer system of claim 14, wherein said one or more systems comprise a development application allowing said content developer to develop the content for a unit based on a developer profile independent of the facilitator that mediates the content to the user of the unit.

16. The computer system of claim 14, wherein said one or more systems comprise an assessment application allowing for said assessor to assess student performance in a learning unit based on an assessor profile independent of a facilitator that mediates the content to a user of the unit.

17. The computer system of claim 14, wherein said one or more systems comprise a facilitation application allowing for said facilitator to mediate the content to the user of the unit according to a facilitator profile.

18. The computer system of claim 11, wherein a unit comprises one of a course, seminar, class, lecture, homework assignment, test, quiz, lab or task.

19. The computer system of claim 11, wherein said assessment application further includes a drop-box application and a communication application for communication with a user.

20. The computer system of claim 11, wherein at least one of an administrator, facilitator or developer sets at least one of the digital rights and asset management application or assessment application to allow user access to assessment information from within at least one the first or second interactive environments.
